(19) United States
(12) Patent Application Publication
(10) Pub. No.: US 2023/0030567 A1
(43) Pub. Date: Feb. 2, 2023

(54) SCREW MEMBER

(71) Applicant: MING-CHENG PAI, PINGTUNG COUNTY (TW)

(72) Inventor: MING-CHENG PAI, PINGTUNG COUNTY (TW)

(21) Appl. No.: 17/388,166

(22) Filed: Jul. 29, 2021

(51) Int. Cl. F16B 39/06; F16B 39/10

(52) U.S. Cl. CPC F16B 39/06; F16B 39/10

(57) ABSTRACT

A threaded fastening assembly composed of a bolt, a nut, a fixing pin, and a positioning piece is revealed. The bolt includes at least one first groove arranged axially on a cylindrical surface of a shank and at least one first threaded segment. The nut has at least one second groove disposed axially on an inner cylindrical surface thereof and at least one second threaded segment. The first and second grooves are aligned to form a locking space for mounting the fixing pin. The positioning piece has a first side with two ends connected to a second side and a third side correspondingly. Inner edges of the second side and the third side are facing and extending toward each other to form convex portions which are matched with the first grooves. The fixing pin is mounted in the locking space for fastening the bolt and the nut.

### BACKGROUND OF THE INVENTION

### Field of the Invention

The present invention relates to a threaded fastening assembly, especially to a threaded fastening assembly formed by a bolt and a nut threaded with each other.

### Description of Related Art

Generally, a bolt and a nut are threaded and positioned by outer threads of the bolt and inner threads of the nut engaged with each other. Vibration or external force causes the assembly of the bolt with the nut to come loose and fall off. Moreover, the longer the length of the bolt, the larger the length of thread engagement and it takes more time to thread the nut onto the bolt. For large area construction, the assembly of the nut and the bolt is time and labor consuming and this has a negative impact on industrial development.

Thus there is room for improvement and there is a need to provide a novel assembly of the nut with the bolt.

### SUMMARY OF THE INVENTION

Therefore, it is a primary object of the present invention to provide a threaded fastening assembly which addresses issues of a conventional assembly of bolt and nut mentioned above.

In order to achieve the above object, a threaded fastening assembly according to the present invention includes a bolt, a nut, a fixing pin, and a positioning piece.

The bolt consists of a head, a shank connected to a bottom surface of the head, at least one first groove arranged axially on a cylindrical surface of the shank, and at least one first threaded segment disposed on a part of the cylindrical surface without the first groove. The first threaded segment includes a plurality of first crests and a plurality of first roots.

The nut is composed of at least one second groove disposed axially on an inner cylindrical surface thereof and at least one second threaded segment arranged at a part of the inner cylindrical surface without the second groove. The second threaded segment includes a plurality of second crests and a plurality of second roots. The second threaded segment is mated and threaded with the first threaded segment while the first groove and the second groove are aligned and combined with each other to form a locking space.

The fixing pin is a cylindrical rod used for being mounted into the locking space.

The positioning piece which includes a first side, a second side, and a third side looks like a horseshoe because that two ends of the first side are connected to the second side and the third side. Inner edges of the second side and the third side are facing and extending toward each other to form convex portions which are matched with the first grooves correspondingly. A distance between the inner edges of the second side and the third side facing each other is not only smaller than an outer diameter of the first crest of the first threaded segment, but also matching an inner diameter of the first root of the first threaded segment.

The present threaded fastening assembly provides the following effects:

1. While inserting the bolt through the nut, the first threaded segment of the bolt and the first groove of the bolt without threads are aligned with the second groove of the nut without threads and the second threaded segment of the nut respectively so that the bolt is moved quickly in the nut without being stopped. After being moved to a desired position, the bolt is rotated to make the first threaded segment of the bolt and the second threaded segment of the nut engage with each other. Thereby the bolt and the nut are threaded with and positioned on each other.

2. After the bolt being inserted through the nut, the fixing pin is mounted into the locking space formed by the first groove together with the second groove to ensure fastening and tightening between the bolt and the nut, without loosening or coining off easily.

3. After a plurality of bolts being inserted through the respective nuts and the desired position being reached, the positioning piece is inserted into the first root of the first threaded segment of the bolt and positioned on the bolt. When the convex portions are locked into the first grooves correspondingly, the positioning piece is positioned on the bolt. The bolt is supported by the positioning piece due to a bottom surface of the positioning piece ranging from the first side to the third side and attached to and abutting against a top surface of the nut. After each of the bolts being inserted into the respective nuts correspondingly and moved to the desired position, the bolts are threaded into the nuts one by one for fastening and positioning. Thereby it takes less time to fasten the bolts with the nuts.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an exploded view of an embodiment of a threaded fastening assembly according to the present invention;

FIG. 2 is a perspective view of an embodiment in which a bolt is inserted through a nut according to the present invention;

FIG. 3 is a side view of an embodiment showing a bolt which is inserted through a nut and capable of moving upward and downward according to the present invention;

FIG. 4 is a cross sectional view of a nut threaded with a bolt of an embodiment according to the present invention;

FIG. 5 is a perspective view showing a positioning piece going to be inserted into a bolt with a nut at a desired position of an embodiment according to the present invention;

FIG. 6 is a perspective view showing a positioning piece already inserted into a bolt with a nut at a desired position of an embodiment according to the present invention;

FIG. 7 is a side view showing a positioning piece inserted into a bolt with a nut of an embodiment according to the present invention;

FIG. 8 is a cross sectional view of a bolt with a nut and a positioning piece of an embodiment according to the present invention;

FIG. 9 is a side view showing a positioning piece inserted into a bolt with a nut of another embodiment according to the present invention;

FIG. 10 is a perspective view showing a fixing pin going to be inserted into a locking space of an embodiment according to the present invention;

FIG. 11 is a perspective view showing a fixing pin already inserted into a locking space of an embodiment according to the present invention;

FIG. 12 is a cross sectional view showing a fixing pin mounted into a locking space of an embodiment according to the present invention;

FIG. 13 a schematic drawing showing a cross-section of a bolt provided with three first grooves equally-angular spaced and a nut provided with three second grooves equally-angular spaced of an embodiment according to the present invention;

FIG. 14 is a schematic drawing showing a cross-section of the embodiment in FIG. 13 in which a fixing pin already mounted into a locking space according to the present invention;

FIG. 15 is a perspective view showing a bolt with a first threaded segment arranged discontinuously of an embodiment according to the present invention;

FIG. 16 is a perspective view showing a head of a bolt is provided with a through hole in which a fixing pin is going to be inserted of an embodiment according to the present invention;

FIG. 17 is a perspective view showing a fixing pin already inserted into a through hole on a head of a bolt of an embodiment according to the present invention.

### DETAILED DESCRIPTION OF THE PREFERRED EMBODIMENT

In order to learn technical content, functions, and features of the present invention more completely and clearly, please refer to the following detailed description with reference of relates figures and reference numerals.

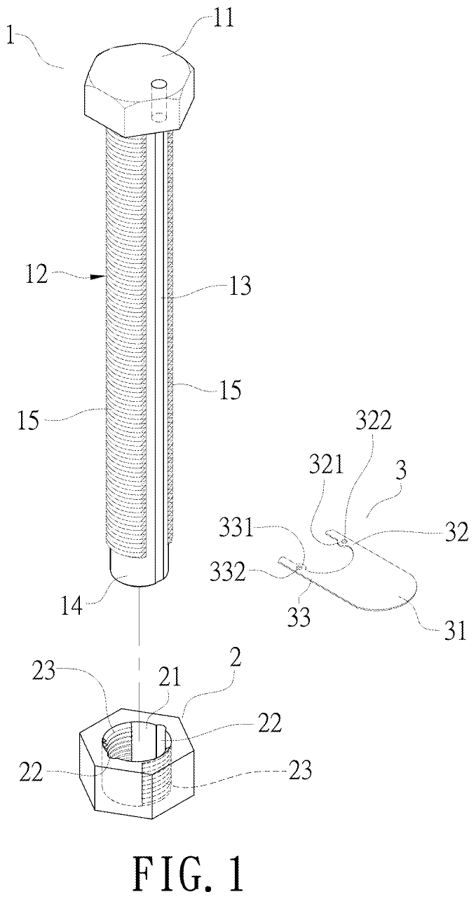

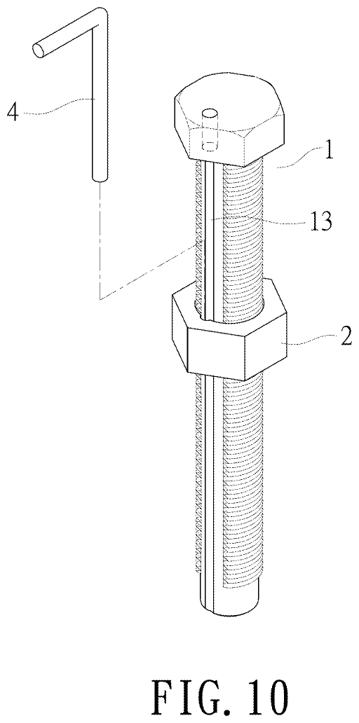

Refer to FIG. 1 and FIG. 10, a threaded fastening assembly according to the present invention includes a bolt 1, a nut 2, and a fixing pin 4.

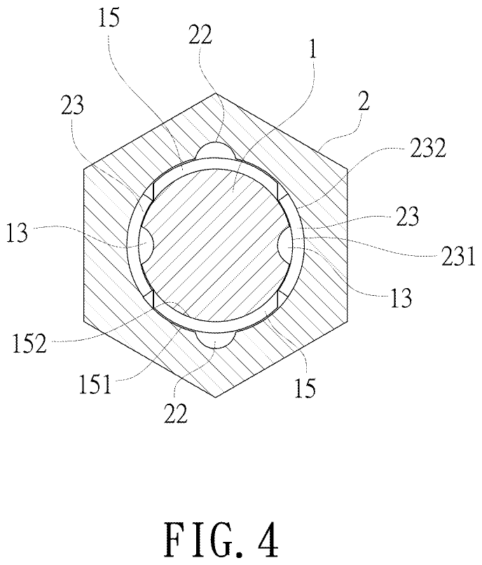

The bolt 1 consists of a head 11, a shank 12 connected to a bottom surface of the head 11, at least one first groove 13 arranged axially on a cylindrical surface 14 of the shank 12, and at least one first threaded segment 15. In this embodiment, there are two first grooves 13 equally-angular spaced around the cylindrical surface 14 of the shank 12 of the bolt 1 (as shown in FIG. 4). The two first threaded segments 15 each of which includes a plurality of first crests 151 and a plurality of first roots 152 are formed on the cylindrical surface 14 between the two first grooves 13 of the shank 12.

The nut 2 is composed of an inner cylindrical surface 21, at least one second groove 22 disposed axially on the inner cylindrical surface 21, and at least one second threaded segment 23. In the embodiment shown in FIG. 1 and FIG. 10, there are two second grooves 22 equally-angular spaced around the inner cylindrical surface 21 of the nut 2. As shown in FIG. 4, the two second threaded segments 23 each of which includes a plurality of second crests 231 and a plurality of second roots 232 are formed between the two second grooves 22 on the inner cylindrical surface 21 of the nut 2.

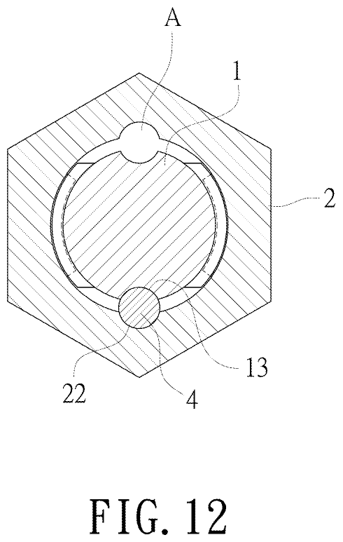

The second threaded segments 23 are mated and threaded with the first threaded segments 15 while the first groove 13 and the second groove 22 are aligned and combined with each other to form a locking space A, as shown in FIG. 12.

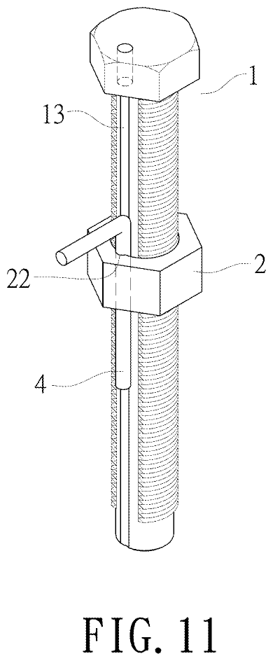

The fixing pin 4 is a cylindrical rod used for being mounted into the locking space A, as shown in FIGS. 10-12.

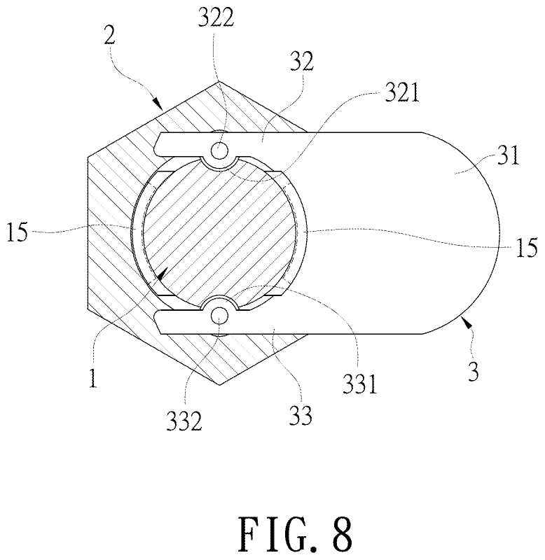

Refer to FIG. 1 and FIG. 8, the threaded fastening assembly according to the present invention further includes a positioning piece 3 which is composed of a first side 31, a second side 32, and a third side 33. Two ends of the first side 31 are connected to the second side 32 and the third side 33 correspondingly so that the positioning piece 3 is in a horseshoe shape. An inner edge of the second side 32 and an inner edge of the third side 33 are facing and extending toward each other to form a convex portion 321 and a convex portion 331 respectively. The concave portions 321, 331 and the first grooves 13 are matched. A distance between the inner edges of the second side 32 and the third side 33 facing each other is not only smaller than an outer diameter of the first crest 151 of the first threaded segment 15, but also matching an inner diameter of the first root 152 of the first threaded segment 15.

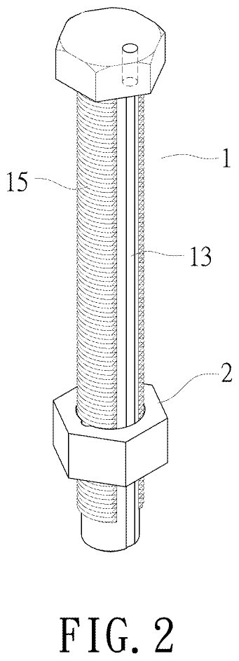

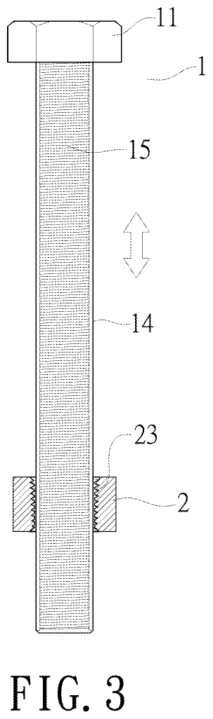

While in use, refer to FIGS. 2-4, first a plurality of the bolts 1 are inserted through the respective nuts 2 correspondingly. The first threaded segment 15 of the bolt 1 is aligned with the inner cylindrical surface 21 without threads on the nut 2 (that's the second groove 22) and the cylindrical surface 14 without threads on the bolt 1 (that's the first groove 13) is aligned with the second threaded segment 23 of the nut 2. Thus the bolt 1 is moved upward and downward quickly in the nut 2 without being stopped. After being moved to a desired position to be threaded, the bolt 1 is rotated to make the first threaded segment 15 of the bolt 1 and the second threaded segment 23 of the nut 2 engage and thread with each other. Thereby the bolt 1 and the nut 2 are fastened and positioned quickly.

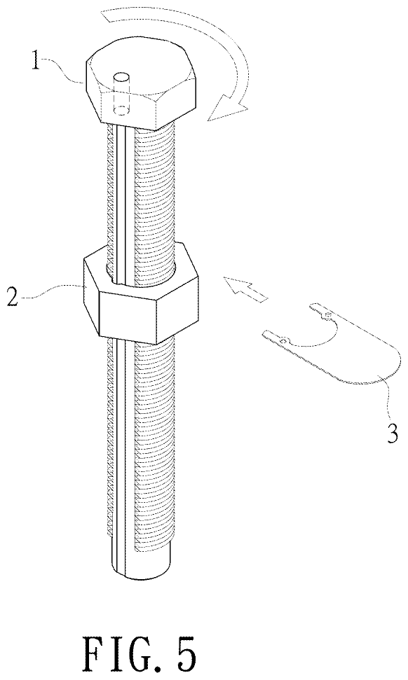

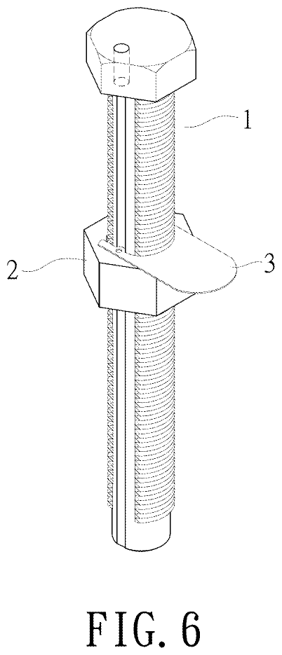

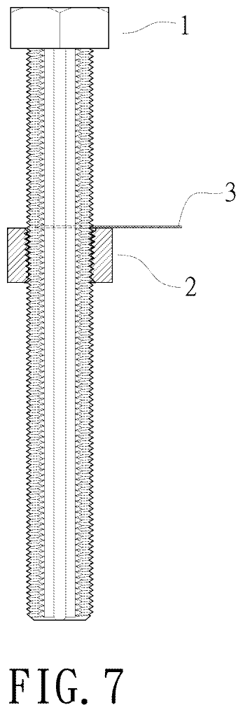

Refer to FIGS. 5-8, when the bolt 1 is inserted through the nut 2 and the desired position is reached, the positioning piece 3 is inserted into one of the first roots 152 of the bolt 1 which is located just above the nut 2. When the convex portion 321 and the convex portion 331 of the positioning piece 3 are locked into the two first grooves 13 on the shank 12 correspondingly, the positioning piece 3 is positioned on the bolt 1. Now even the bolt 1 is released, the bolt 1 is supported by the positioning piece 3 without falling off due to a bottom surface of the positioning piece 3 ranging from the first side 31 to the third side 33 and attached to and abutting against a top surface of the nut 2. After each of the bolts 1 being inserted through the nut 2 and moved to the desired position, the positioning pieces 3 are removed and the bolts 1 are rotated to be threaded and positioned in the nuts 2 for fastening and positioning. Next the fixing pin 4 is mounted into the locking space A formed by the first groove 13 in combination with the second groove 22 to complete fastening of the bolt 1 with the nut 2 quickly, as shown in FIGS. 10-12.

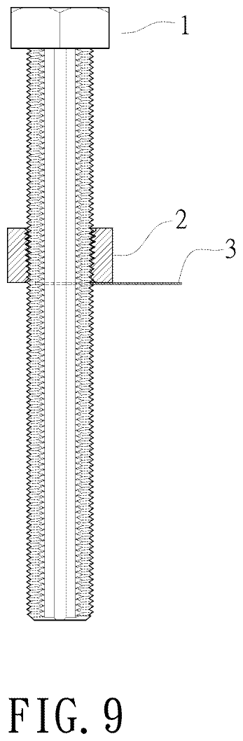

As shown in FIG. 9, the positioning piece 3 is inserted into one of the first roots 152 of the bolt 1 which is located just under the nut 2 so that a top surface ranging from the first side 31 to the third side 33 of the positioning piece 3 is attached to and abutting against a bottom surface of the nut 2. Thereby the connection and primary fixing of the bolt 1 with the nut 2 at the desired position are achieved. Moreover, for convenience of removing the positioning piece 3, the convex portion 321 and the convex portion 331 of the positioning piece 3 are respectively provided with a hole 322 and a hole 332 in which tools are inserted to force the convex portions 321, 331 being released from the first groove 13 of the bolt 1.

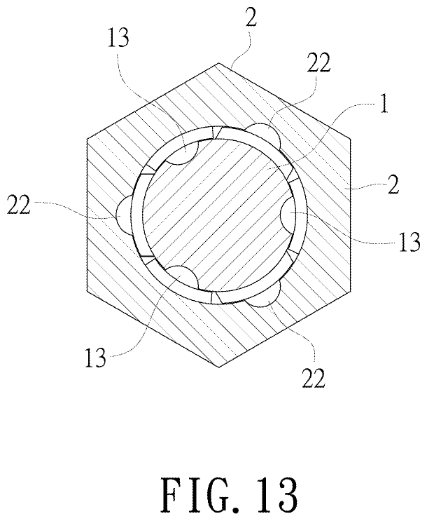

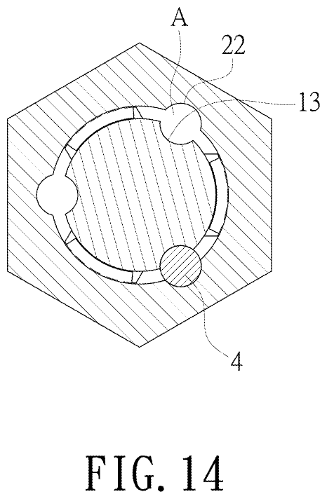

Refer to FIG. 13 and FIG. 14, another embodiment is revealed. The structure of this embodiment is about the same as the structure of the embodiment in FIGS. 1-12 while a difference between this embodiment and the above one shown in FIGS. 1-12 is in that the shank 12 of the bolt 1 is provided with three first grooves 13 and a first threaded segment 15 is formed between the two adjacent first grooves 13 in this embodiment. There are three second grooves 22 on the inner cylindrical surface 21 of the nut 2 and a second threaded segment 23 is formed between the two adjacent second grooves 22. This embodiment achieves the same effects as the embodiment shown in FIGS. 1-12.

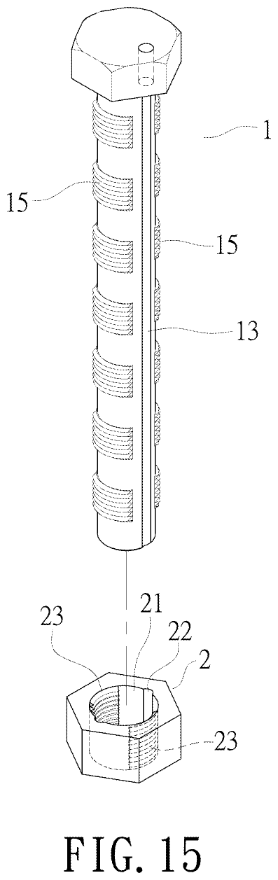

The first threaded segments 15 which are equally-angular spaced around the shank 12 of the bolt 1 can be provided continuously or discontinuously, as shown in FIG. 1 and FIG. 15 respectively.

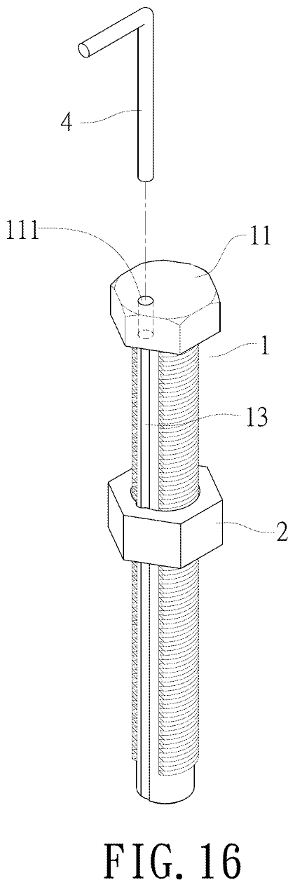

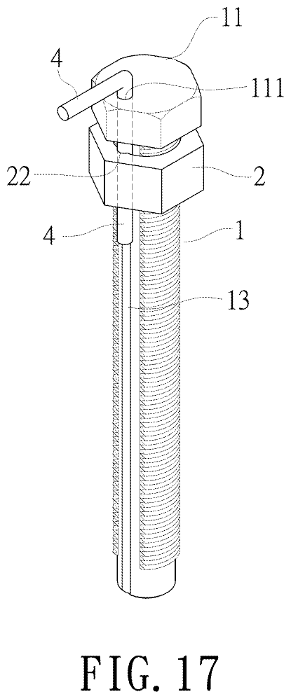

Refer to FIG. 16 and FIG. 17, the head 11 of the bolt 1 is provided with a through hole 111 communicated with the first groove 13. After the bolt 1 and the nut 2 being fastened with each other, the fixing pin 4 is inserted through the through hole 111 and mounted into the locking space A which is formed by the first groove 13 in combination with the second groove 22.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A threaded fastening assembly comprising: a bolt, a nut, a fixing pin, and a positioning piece;
wherein the bolt includes a head, a shank connected to a bottom surface of the head, at least one first groove arranged axially on a cylindrical surface of the shank, and at least one first threaded segment disposed on a part of the cylindrical surface without the first groove; the first threaded segment is provided with a plurality of first crests and a plurality of first roots;
wherein the nut is provided with at least one second groove disposed axially on an inner cylindrical surface of the nut and at least one second threaded segment arranged at a part of the inner cylindrical surface without the second groove; the second threaded segment which includes a plurality of second crests and a plurality of second roots is mated and threaded with the first threaded segment while the first groove and the second groove are aligned and combined with each other to form a locking space;
wherein the fixing pin is a cylindrical rod used for being mounted into the locking space; and
wherein the positioning piece includes a first side, a second side, and a third side; two ends of the first side are connected to the second side and the third side correspondingly so that the positioning piece is in a horseshoe shape; an inner edge of the second side and an inner edge of the third side are facing and extending toward each other to form a convex portion respectively; the concave portions and the first grooves are matched; a distance between the inner edge of the second side and the inner edge of the third side facing each other is not only smaller than an outer diameter of the first crest of the first threaded segment, but also matching an inner diameter of the first root of the first threaded segment.

2. The threaded fastening assembly as claimed in claim 1, wherein the two first grooves are equally-angular spaced around the cylindrical surface of the shank of the bolt; wherein the first threaded segment is formed on the cylindrical surface between the two first grooves and the two first threaded segments are equally-angular spaced; the two second grooves are equally-angular spaced around the inner cylindrical surface of the nut;
wherein the second threaded segment is formed on the inner cylindrical surface between the two second grooves and the two second threaded segments are equally-angular spaced.

3. The threaded fastening assembly as claimed in claim 2, wherein the convex portion of the second side and the convex portion of the third side are both provided with a hole.

4. The threaded fastening assembly as claimed in claim 3, wherein the head of the bolt is provided with a through hole communicated with the first groove.

5. The threaded fastening assembly as claimed in claim 1, wherein the convex portion of the second side and the convex portion of the third side are both provided with a hole.

6. The threaded fastening assembly as claimed in claim 2, wherein the head of the bolt is provided with a through hole communicated with the first groove.

7. The threaded fastening assembly as claimed in claim 1, wherein the head of the bolt is provided with a through hole communicated with the first groove.

8. The threaded fastening assembly as claimed in claim 1, wherein the three first grooves are equally-angular spaced around the cylindrical surface of the shank of the bolt; wherein the first threaded segment is formed on the cylindrical surface between the two adjacent first grooves and the three first threaded segments are equally-angular spaced; the three second grooves are equally-angular spaced around the inner cylindrical surface of the nut; wherein the second threaded segment is formed on the inner cylindrical surface between the two adjacent second grooves and the three second threaded segments are equally-angular spaced.

9. The threaded fastening assembly as claimed in claim 8, wherein the convex portion of the second side and the convex portion of the third side are both provided with a hole.

10. The threaded fastening assembly as claimed in claim 9, wherein the head of the bolt is provided with a through hole communicated with the first groove.

11. The threaded fastening assembly as claimed in claim 8, wherein the head of the bolt is provided with a through hole communicated with the first groove.
